(19) United States
(12) Patent Application Publication
(10) Pub. No.: US 2002/0041750 A1
(43) Pub. Date: Apr. 11, 2002

(54) Rare earth element-doped, Bi-Sb-Al-Si glass and its use in optical amplifiers

(76) Inventors: Lisa C. Chacon, Corning, NY (US); Lauren K. Cornelius, Painted Post, NY (US); Adam J. Ellison, Corning, NY (US)

Correspondence Address: Michael L. Goldman, NIXON PEABODY LLP, Clinton Square, P.O. Box 31051, Rochester, NY, 14603, US

(21) Appl. No.: 09/884,525

(22) Filed: Jun. 19, 2001

Related U.S. Application Data
(60) Provisional application No. 60/212,861, filed on Jun. 20, 2000.

(51) Int. Cl. G02B 6/00

(52) U.S. Cl. 385/141

(57) ABSTRACT

The present invention relates to a rare earth element-doped, Bi₂O₃—Sb₂O₃—Al₂O₃—SiO₂ glass including about 1-50 mol % Bi₂O₃. The present invention also relates to an optical amplifier having an active region formed of a rare earth element-doped, Bi₂O₃—Sb₂O₃—Al₂O₃—SiO₂ glass including about 1-50 mol % Bi₂O₃.

This application claims the benefit of U.S. Provisional Patent Application Ser. No. 60/212,861, filed Jun. 20, 2000, which is hereby incorporated by reference in its entirety.

### FIELD OF THE INVENTION

The present invention relates to a rare earth element-doped, Bi₂O₃—Sb₂O₃—Al₂O₃—SiO₂ glass and its use in optical amplifiers.

### BACKGROUND OF THE INVENTION

The increasing demand for improved fiber optic components in telecommunications systems and in medical devices has led to the need for novel glasses. The telecommunications industry utilizes waveguide amplifiers to intensify optical signals that have been attenuated along the length of a fiber optic communication path. Optical communication systems usually operate in two separate bands, namely at about 1300 nm and at about 1550 nm. Typically, these fiber optic components utilize glasses which have been doped with a rare earth element. Doping with rare earth elements generally enables the production of glass materials capable of efficient, low-loss optical transmission and amplification at desired fluorescence bands. For example, erbium has been used as a dopant for amplifiers operating in the 1550 nm band, whereas neodymium, dysprosium, or praseodymium are used as dopants in amplifiers operating in the 1300 nrn band. U.S. Pat. No. 3,729,690 to Snitzer describes a glass suitable for use as a laser comprising a host material that contains a fluorescent trivalent neodymium ingredient. U.S. Pat. No. 5,027,079 to Desurvire et al. describes an optical amplifier comprising a single mode fiber that has an erbium-doped core. Also, U.S. Pat. No. 5,239,607 to da Silva et al. describes an apparatus and method for flattening the gain of an optical amplifier that utilizes an erbium-doped silica fiber having a germanosilicate core. U.S. Pat. No. 5,563,979 to Bruce et al. describes an erbium-doped planar optical device whose active core includes a mixture of oxides such as lanthanum and aluminum oxides.

Suitable glasses which may be used in optical components such as those described above must be stable (i.e., resist devitrification). For example, heavy metal fluoride glasses exhibit poor resistance to devitrification. U.S. Pat. No. 4,674,835 to Mimura et al. discusses the crystallization problems of heavy metal fluoride glasses, one example of which is referred to as ZBLAN, and the light scattering problems resulting therefrom. Preferably, the glasses are formed using conventional glass-forming techniques which do not require additional production costs and are compatible with currently available cladding materials. Finally, the glass must possess certain characteristics. One characteristic, as it pertains to use as an optical amplifier, concerns the gain measured against the width of the amplification band (i.e., gain curve). It is preferable for optical amplifiers to have a broader, flatter gain curve. However, many oxide glasses do not display a gain curve which is sufficiently flat (i.e., less than ten percent gain deviation) over a broad amplification band (i.e., greater than 32 nm).

The inclusion of antimony in glasses for optical devices is described in, for example, U.S. Pat. No. 5,283,211 to Aitken et al., which describes a glass for use in waveguides that contains 50-75 mol % SbO_{1.5}, 5-50% TlO_{0 5}, and 0-20% PbO, and PCT Publication No. WO 99/51537 to Dickinson et al., which describes a glass consisting essentially of Sb₂O₃ and up to 4% RE₂O₃, where RE is a rare earth element, and can include 0-99% SiO₂, 0-99% GeO₂, 0-75% Al₂O₃ or Ga₂O₃, and up to 10 mol % B₂O₃.

However, there remains a need for new, readily prepared glasses that display an optimal combination of gain flatness and breadth for the construction of efficient optical amplifiers.

The present invention is directed toward overcoming the above-noted deficiencies in the prior art.

### SUMMARY OF THE INVENTION

The present invention relates to a rare earth element (“REE”)-doped, Bi₂O₃—Sb₂O₃—Al₂O₃—SiO₂ glass including about 1-50 mol % Bi₂O₃.

The present invention also relates to an optical amplifier having an active region formed of a REE-doped, Bi₂O₃—Sb₂O₃—Al₂O₃—SiO₂ glass including about 1-50 mol % Bi₂O₃.

The incorporation of Bi₂O₃ into the glass of the present invention allows for the broadening of the REE emission and is easier to incorporate than F⁻. In addition, bismuth is non-toxic, whereas other elements, such as antimony, have toxicity issues surrounding their use. The glass of the present invention is highly desirable because it can be fabricated in air using standard melting techniques and batch reagents. The glass so obtained has a gain spectrum with excellent breadth and flatness characteristics and can be readily modified for specific optical amplifier applications.

### BRIEF DESCRIPTION OF THE DRAWINGS

FIG. 1 shows the emission spectra of various glass formulations including compositions 1, 2 and 5 (See Table 1 for the compositions of the above-identified glass formulations).

FIG. 2 shows a schematic diagram of a first embodiment of an optical fiber amplifier of the present invention.

FIG. 3 shows a schematic diagram of a second embodiment of an optical fiber amplifier of the present invention.

FIG. 4 shows a schematic diagram of a third embodiment of an optical fiber amplifier of the present invention.

FIG. 5 shows a ternary diagram of the glass forming region of the Bi₂O₃+Sb₂O₃, Al₂O₃, SiO₂ glass composition family.

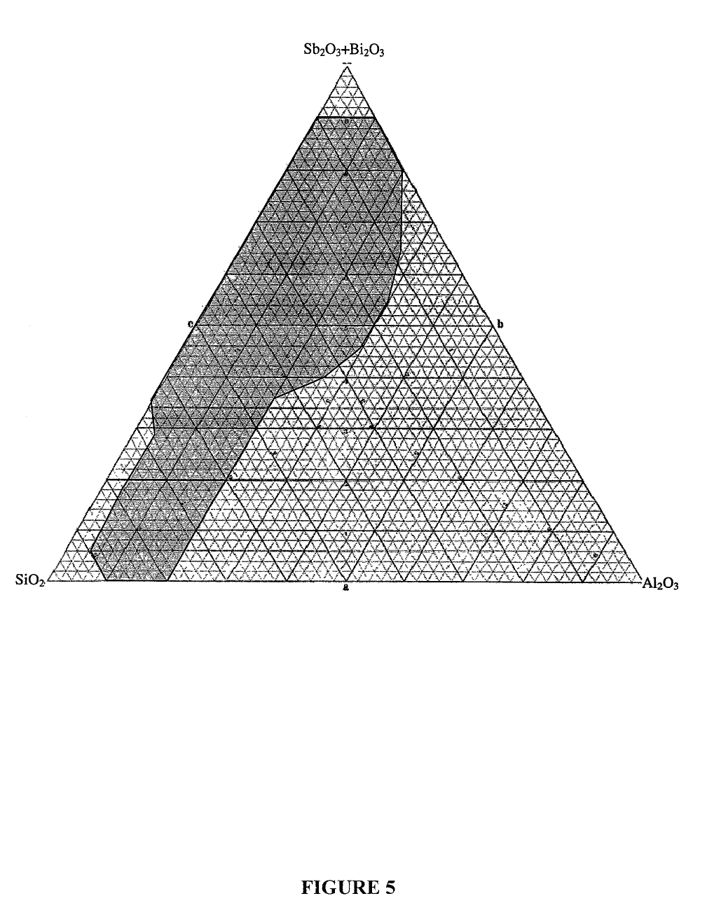

### DETAILED DESCRIPTION OF THE INVENTION

The present invention relates to a REE-doped, Bi₂O₃—Sb₂O₃—Al₂O₃—SiO₂ glass including about 1-50 mol % Bi₂O₃.

Preferably, the glass of the present invention includes about 0-4 mol % REE oxide.

The REE include Y, La, Ce, Pr, Nd, Pm, Sm, Eu, Gd, Tb, Dy, Ho, Er, Tm, Yb, and Lu. Preferably, the REE in the REE oxide is Er, Tm, Yb, Nd, or Ce. Most preferably, the REE in the REE oxide is Er, Tm, or Yb. In accordance with the present invention, Er is especially preferred because of its emission near the 1550 nm band.

In a preferred embodiment, the glass of the present invention includes from about 1 to about 50 mol % Bi₂O₃ and about 0.1 mol % Er₂O₃.

In another preferred embodiment, the glass of the present invention includes from about 1 to about 50 mol % Bi₂O₃ and about 0.1 mol % Tm₂O₃.

Most preferably, the glass of the present invention includes batched compositions of about 1-60 mol % Sb₂O₃, about 1-60 mol % Bi₂O₃, about 0-20 mol % Al₂O₃, about 20-90 mol % SiO₂, and about 0-4 mol % Er₂O₃. In one embodiment, the glass of the present invention includes about 21-60 mol % Sb₂O₃. In another embodiment, the glass of the present invention includes about 10-60 mol % Bi₂O₃.

The preferred glass of the present invention may also contain various other modifiers, each of which has a different effect on the properties of the resulting glass. For example, additional elements such as B₂O₃ (0-10 mol %), GeO₂ (0-50 mol %), As₂O₃ (0-15 mol %), and ZnO, TiO₂, Ga₂O₃, K₂O and Na₂O (0-5 mol %) can be incorporated to modify the physical or optical properties of the glass.

Although heavy metal bismuthate glasses are known, Bi₂O₃ was expected to give a black opal in this glass family due to the reduction of bismuth to the metallic state. In contrast, the glasses of the present invention are yellow to deep red and transparent. The presence of even small amounts of Sb₂O₃ or As₂O₃ enables high levels of Bi₂O₃ to be achieved in transparent glasses, by buffering the redox state of the melt to avoid reduction of the bismuth.

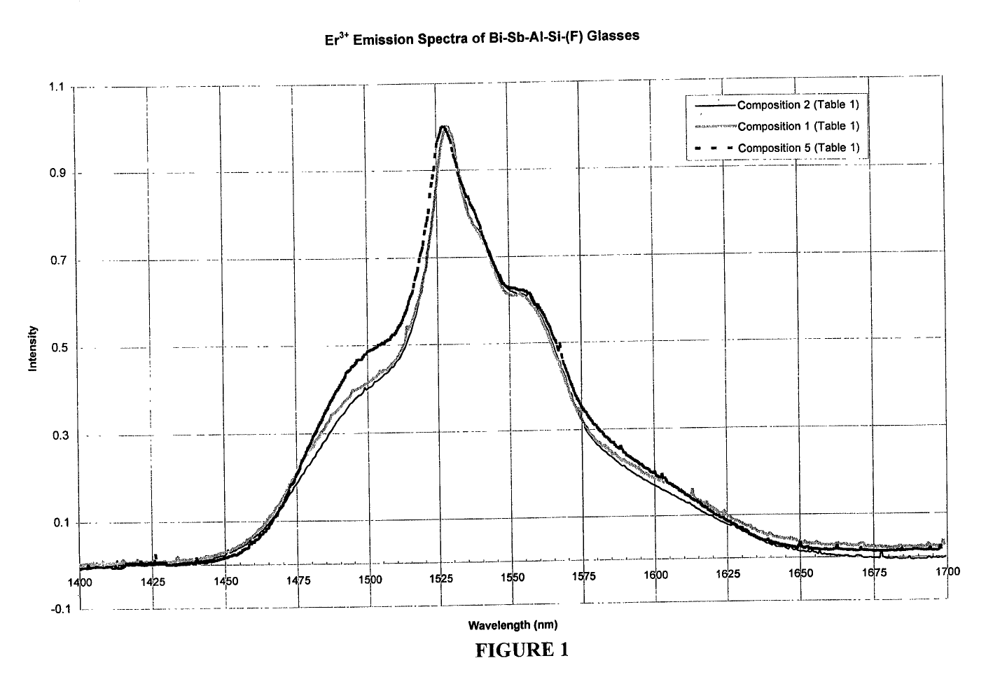

The incorporation of Bi₂O₃ into the glass of the present invention has the effect of broadening the REE emission, as shown in FIG. 1. Further, the glass of the present invention is highly desirable because it can be fabricated in air using standard melting techniques and batch reagents. In addition, the glass of the present invention is stable against devitrification, compatible with currently available silica cladding materials, and easily drawn into fibers. Moreover, the glass so obtained has a gain spectrum with excellent breadth and flatness characteristics and can be readily modified for specific optical amplifier applications.

The local bonding environments of rare earth elements in glasses determine the characteristics of their emission and absorption spectra. Several factors influence the width, shape, and absolute energy of emission and absorption bands, including the identity of the anion(s) and next-nearest-neighbor cations, the symmetry of any particular site, the total range of site compositions and symmetries throughout the bulk sample, and the extent to which emission at a particular wavelength is coupled to phonon modes within the sample.

Modifications to the glass composition may be made to improve fluorescence intensities and emission lifetimes, and also to modify liquifaction temperatures, viscosity curves, expansivity, and refractive index. The content of alkali and alkaline earth metals and additional elements included in the glass may be adjusted to vary the refractive index and to increase or decrease thermal expansivity. Glasses containing optically active REE can be co-doped with non-active REE (for example, Er co-doped with La or Y) to increase emission lifetimes, or co-doped with optically active REE (such as Er co-doped with Yb) to improve quantum efficiency. By varying bulk composition, glasses can be formed with maximum flexibility in optical properties.

The glass of the present invention is characterized by low-loss transmission in the infrared as well as surprising gain characteristics at the optimum amplification window. These properties of the glass make it particularly useful for the fabrication of a variety of optical devices. Provided with a compatible covering or cladding, the glass can be formed into optical amplifiers or lasers. Examples of methods for forming glass fiber preforms include: outside vapor deposition, vapor axial deposition, modified chemical vapor deposition, and plasma-enhanced chemical vapor deposition, all of which are well known in the art; liquid atomized feed for external chemical deposition, as described in U.S. Provisional Application Ser. No. 60/095,736, which is hereby incorporated by reference in its entirety; sol-gel, as described in U.S. Pat. No. 5,123,940 to DiGiovanni et al., which is hereby incorporated by reference in its entirety; solution doping, as described in U.S. Pat. No. 4,923,279 to Ainslie et al., which is hereby incorporated by reference in its entirety; and the cullet-in-tube method, as described in U.S. Provisional Patent Application Ser. No. 60/050,469, which is hereby incorporated by reference in its entirety. Once the preform is prepared, a fiber can be drawn by conventional techniques. For example, it is well known to draw glass fibers from a specially prepared, cylindrical preform which has been locally and symmetrically heated to a temperature, e.g., a temperature corresponding to a viscosity of 10⁵ to 10⁶ poise. As the preform is heated, such as by feeding the preform into and through a furnace, a glass fiber is drawn from the molten material.

The glass of the present invention can also be used alone in planar amplifier applications. Planar waveguides can be formed by modifying the above-described soot deposition techniques to include conventional lithographic techniques for the introduction of optical circuitry to the planar waveguide. Alternatively, planar waveguides may be prepared according to the method set forth in U.S. Pat. No. 5,125,946 to Bhagavatula, which is hereby incorporated by reference in its entirety.

The glass of the present invention can be formed into fiber preforms by double-crucible fiberization or rod-and-tube redraw with appropriate clad glass compositions. In addition, the emission/absorption spectra of glasses prepared in accordance with the invention may be tailored to “fill in holes” in the gain spectrum of conventional amplifier materials, silica or ZBLAN, for example, resulting in hybrid amplifiers that provide a greater degree of gain flatness than can be obtained from any of these materials alone.

The glass material of the invention can be produced according to conventional techniques for making glasses such as batch melting, sol-gel, etc. Using a conventional batch melting technique, the glass is formed by providing a batch mixture that has a composition as set forth above. The batch materials are then treated under conditions effective to produce a glass matrix. The treatment generally comprises calcining batch materials at around 450° C., followed by melting the batch materials at a temperature of from about 1200° C. to about 1550° C. for from about 1 to about 20 hours in silica, alumina, or zirconia crucibles, to produce a glass melt and annealing at around 350° C., followed by cooling the glass melt to produce the glass matrix. Glass samples for analysis are typically prepared by pouring a patty of glass into a mold of a volume ranging from about 4 inches×8 inches×0.5 inches to about 3 inches diameter×0.25 inches. Moreover, depending upon the desired use of the glass, the glass melt may be formed into a shaped article by forming procedures such as, for example, rolling, pressing, casting, or fiber drawing. The resulting shaped article, which is preferably a patty, rod, sheet, or fiber, is cooled and then, optionally annealed. After annealing, the shaped article is allowed to cool to room temperature.

Variations of the above-described manufacturing process are possible without departing from the scope of the present invention. For example, because the glass manufacturing process is temperature-time dependent, it is possible to vary the dwell time of the glass forming and annealing steps depending upon the rate of heating.

The core and cladding layer are typically produced in a single operation by methods which are well known in the art. Suitable methods include: the double crucible method as described, for example, in Midwinter, Optical Fibers for Transmission, New York, John Wiley, pp. 166-178 (1979), which is hereby incorporated by reference in its entirety; rod-in-tube procedures; liquid atomized feed for external chemical deposition as described in U.S. Provisional Patent Application Ser. No. 60/095,736, which is hereby incorporated by reference in its entirety, and doped deposited silica processes, also commonly referred to as chemical vapor deposition (“CVD”) or vapor phase oxidation. A variety of CVD processes are known and are suitable for producing the core and cladding layer used in the optical fibers of the present invention. They include external CVD processes (Blakenship et al., “The Outside Vapor Deposition Method of Fabricating Optical Waveguide Fibers,” IEEE J. Quantum Electron., 18:1418-1423 (1982), which is hereby incorporated by reference in its entirety), axial vapor deposition processes (Inada, “Recent Progress in Fiber Fabrication Techniques by Vapor-phase Axial Deposition,” IEEE J. Quantum Electron. 18:1424-1431 (1982), which is hereby incorporated by reference in its entirety), and modified CVD or inside vapor deposition (Nagel et al., “An Overview of the Modified Chemical Vapor Deposition (MCVD) Process and Performance,” IEEE J. Quantum Electron. 18:459-476 (1982), which is hereby incorporated by reference in its entirety).

In a preferred embodiment, the glass of the present invention is produced by melting of materials from oxide constituents. In another preferred embodiment, the glass of the present invention is produced by CVD.

The present invention also relates to an optical energy-producing or -amplifying device, in particular, an optical amplifier having an active region formed of a REE-doped, Bi₂O₃—Sb₂O₃—Al₂O₃—SiO₂ glass including about 1-50 mol % Bi₂O₃. In one embodiment, the optical amplifier of the present invention has an active region in the infrared.

As used herein, an optical amplifier is a device that amplifies an input optical signal without converting it into electrical form (Hecht, Understanding Fiber Optics, 2^{nd} ed., Prentice-Hall, Inc., New Jersey (1993), which is hereby incorporated by reference in its entirety).

The optical amplifier can be a fiber amplifier or a planar amplifier, as described in, for example, U.S. Pat. Nos. 5,027,079, 5,239,607, and 5,563,979, which are hereby incorporated by reference in their entirety. The fiber amplifier can further be of a hybrid structure that combines legs formed from a glass of the invention with legs formed from a standard aluminosilicate glass, as described, for example, in Yamada et al., “Flattening the Gain Spectrum of an Erbium-Doped Fiber Amplifier by Connecting an Er³⁺-doped SiO₂—Al₂O₃ Fiber and an Er³⁺-doped Multicomponent Fiber,” Electronics Lett., 30:1762-1764 (1994), which is hereby incorporated by reference in its entirety.

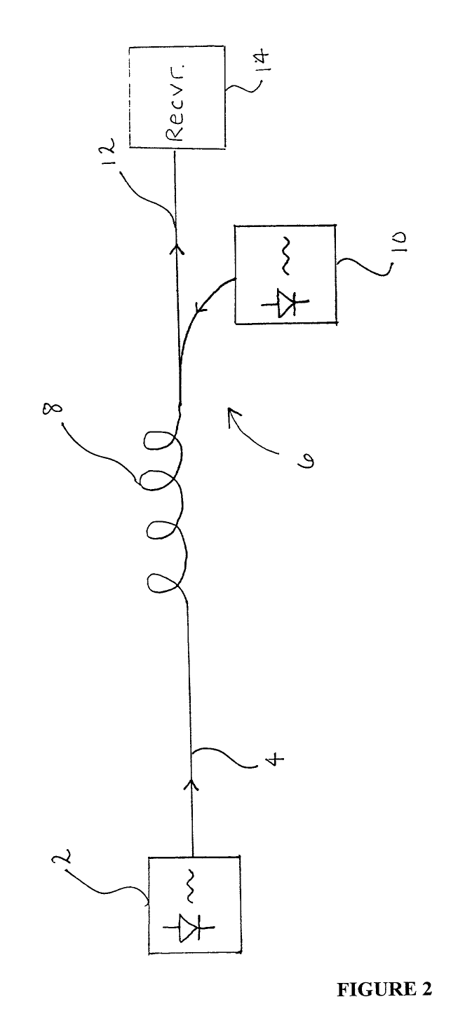

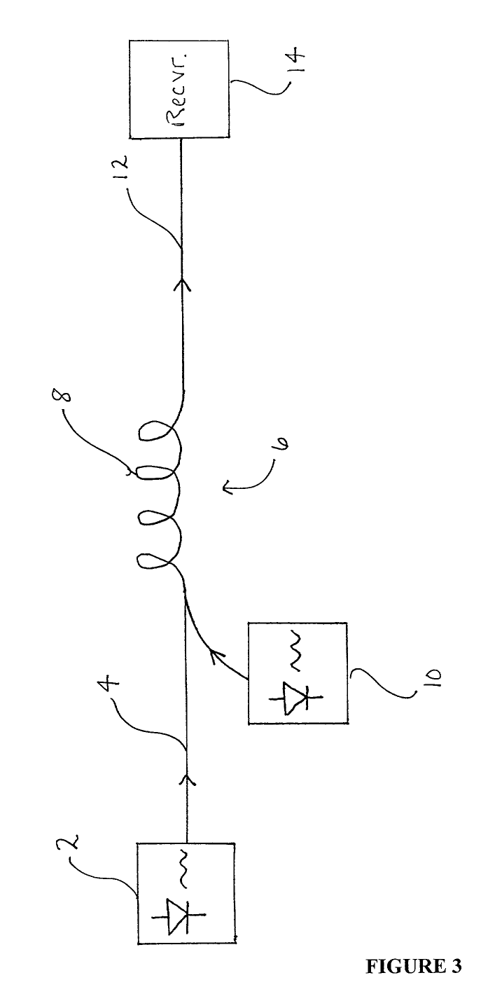

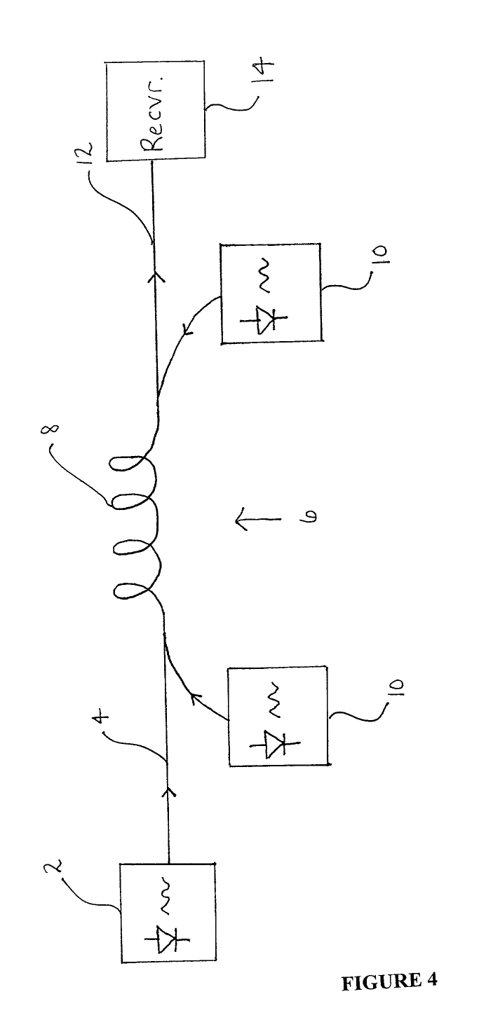

As shown in FIG. 2, an embodiment of the fiber amplifier of the present invention includes several elements found in conventional fiber amplifiers. In particular, a transmitter 2, which provides input signals, is coupled to an input fiber 4. A fiber amplification stage 6 includes an active region 8 formed of a REE-doped, Bi₂O₃—Sb₂O₃—Al₂O₃—SiO₂ glass waveguide including about 1-50 mol % Bi₂O₃ and a pump laser 10, where the pump radiation traverses active region 8 in the direction opposite from that of the optical signal to be amplified. The active region 8 is usually spliced on either end to passive, undoped silica fiber. The output of the amplification stage 6 is connected to an output fiber 12 which supplies the amplified signal to a receiver 14. In this embodiment, the optical amplifier is pumped from the back. In FIG. 3, a fiber amplifier pumped from the front is shown. In FIG. 4, a fiber amplifier pumped from both the front and back is shown.

For an active region formed of an erbium doped glass of the present invention, the input signals are from about 1500 nm to about 1600 nm. In addition, the pump laser 10 is usually a semiconductor laser. The pump laser 10 illuminates the fiber amplifier from the opposite end to the input signal by a stronger beam at a shorter wavelength. Light from the pump laser excites the rare earth ions, raising them to a series of higher energy states where they oscillate between these states at a transition energy or frequency corresponding to the optical signal to be amplified. Light at the signal wavelength can stimulate these excited ions to emit their excess energy as light at the signal wavelength, and in phase with the signal pulses. Further, ytterbium can be added to the fiber to absorb light at a broad range of other wavelengths, including the 1064 nm output of neodymium-YAG lasers; the ytterbium can transfer the energy it absorbs to the erbium, exciting them so the fiber amplifier can be pumped with other wavelengths. Praseodymium-doped fibers can amplify light at 1280 nm to 1330 nm when pumped with a laser at 1017 nm.

For optical amplifier applications, the region over which a convolution of the emission and absorption is the flattest is the optimal window through which to pass signals. Because both the position of the overall emission bands and the structure within the band vary from fluoride to oxide hosts, the window with optimal gain flatness also varies. Ideally, one would like to obtain the broadest emission possible in a single glass. A flat emission spectrum is defined as one having less than 10% gain deviation over bands (or windows) up to 32 nm wide. The glass of the present invention achieves the desired gain flatness, which presenting significantly broader windows of the emission spectra.

### EXAMPLES

### Example 1

### Preparation of an Erbium-doped, Bismuth-containing Antimony, Aluminum, Silicon Glass

A novel bismuth-containing glass was developed for erbium-doped optical amplifiers which incorporates between 1 and 50 mol % Bi₂O₃. Examples are given in Table 1, below.

Composition 1 was derived by the substitution of 10 mol % Bi₂O₃ for Sb₂O₃ in the reference glass, composition 2 (Table 1). Table 1 also shows the compositions of additional Bi₂O₃-containing glasses, where all compositions were melted in silica crucibles, except for composition 13, which was melted in an alumina crucible, and compositions 23 and 24, which were melted in a zirconia crucible. The effect of Sb₂O₃ was demonstrated by composition 14. If Sb₂O₃ was left out of a batch of the remaining oxides in their appropriate proportions, the melt produced an opaque glass, but when containing 5 mol % Sb₂O₃ (batched), it produced a transparent glass.

TABLE 1
Compositions of Sb-Bi-Al-Si Glasses (mol % batched or analyzed)

| Composition | Bi₂O₃ | Sb₂O₃ | Al₂O₃ | SiO₂ | As₂O₃ | GeO₂ | Other | Er₂O₃ |
|---|---|---|---|---|---|---|---|---|
| 1 | 10 | 35 | 20 | 35 | — | — | — | 0.03 |
| 2 | — | 45 | 20 | 35 | — | — | — | 0.03 |
| 3 | 1 | 44 | 20 | 35 | — | — | — | 0.03 |
| 4 | 5 | 40 | 20 | 35 | — | — | — | 0.03 |
| 5 | — | 45 | 15 | 35 | — | — | AlF₃/5 | 0.03 |
| 6 | 25 | 45 | 10 | 20 | — | — | — | 0.1 |
| | 22.2 | 38.4 | 8.6 | 30.8 | | | | 0.09 |
| 7 | 50 | 1 | 15 | 34 | — | — | — | 0.1 |
| | 51.3 | 1.2 | 15 | 32.4 | | | | 0.1 |
| 8 | 30 | 5 | 15 | 50 | — | — | — | 0.1 |
| | 37 | 6.1 | 18.1 | 38.7 | | | | 0.1 |
| 9 | 80 | 5 | 15 | 0 | — | — | — | 0.1 |
| | 54.4 | 3.4 | 10.6 | 31.6 | | | | 0.06 |
| 10 | 70 | 5 | 15 | 10 | — | — | — | 0.1 |
| | 55 | 4 | 11.1 | 29.9 | | | | 0.09 |
| 11 | 45 | 45 | 0 | 10 | — | — | — | 0.1 |
| | 28.7 | 38.8 | 0 | 32.3 | | | | 0.12 |
| 12 | 6.7 | 6.7 | 6.7 | 80 | — | — | — | 0.1 |
| | 10.7 | 12.1 | 10.2 | 66.9 | | | | 0.17 |
| 13 | 40 | 5 | 5 | 50 | — | — | — | 0.1 |
| | 44.5 | 6.6 | 12.6 | 36.1 | | | | 0.17 |
| 14 | 10 | 5 | 5 | 80 | — | — | — | 0.1 |
| | 11.3 | 5.4 | 5.6 | 77.6 | | | | 0.17 |
| 15 | 99 | 1 | — | 0 | — | — | — | 0.1 |
| | 50.2 | 0.5 | | 49.2 | | | | 0.08 |
| 16 | 95 | 5 | — | 0 | — | — | — | 0.1 |
| | 48.2 | 2.4 | | 49.3 | | | | 0.08 |
| 17 | 90 | 10 | — | 0 | — | — | — | 0.1 |
| | 48.4 | 5.0 | | 46.6 | | | | 0.06 |
| 18 | 99 | — | — | 0 | 1 | — | — | 0.1 |
| | 49.7 | | | 49.9 | 0.3 | | | 0.06 |
| 19 | 32 | — | 15 | 50 | 3 | — | — | 0.1 |
| 20 | 100 | — | — | 0 | — | — | — | 0.1 |
| | 49.9 | | | 51.1 | | | | 0.06 |
| 21 | 25 | 25 | — | — | — | 50 | — | 0.1 |
| 22 | 25 | 25 | 10 | 10 | — | 40 | — | 0.1 |
| | 22.7 | 20.7 | 8.9 | 12.7 | | 34.9 | | 0.1 |
| 23 | 10 | 5 | 5 | 80 | — | — | ZrO₂/0 | 0.1 |
| | 10.5 | 5.0 | 5.6 | 78.6 | | | 0.12 | 0.12 |
| 24 | 15 | — | 5 | 80 | — | — | ZrO₂/0 | 0.1 |
| | 15.6 | | 5.5 | 78.6 | | | 0.11 | 0.12 |
| 25 | 10 | 35 | 10 | 35 | — | — | B₂O₃/10 | 0.03 |
| 26 | 25 | 25 | 10 | 36 | — | — | — | 4 |
| 27 | 2.5 | 2.5 | 5 | 90 | — | — | — | 0.1 |

### Example 2

### Spectroscopic Analysis of Glass Samples

The emission spectrum of Composition 1, prepared as described in Example 1, was compared with the emission spectrum of related Bi—Sb—Al—Si compositions 2 and 5 shown in Table 1 (FIG. 1). The incorporation of 10 mol % Bi₂O₃ had the effect of broadening the erbium emission slightly, as shown in FIG. 1. It is expected that further substitution of Bi₂O₃ for Sb₂O₃ in this composition family will lead to further broadening, possibly even to the same degree as the addition of F⁻ to the reference composition (e.g., Table 1, composition 5). This would be advantageous, as F⁻ is difficult to incorporate via CVD or vapor infiltration, whereas Bi₂O₃ should be easily delivered as a vapor in a CVD process or as a soluble organometallic compound in the liquid atomized feed for external chemical deposition method. Finally, bismuth is non-toxic whereas antimony has toxicity issues surrounding its use.

Although the invention has been described in detail for the purpose of illustration, it is understood that such detail is solely for that purpose, and variations can be made therein by those skilled in the art without departing from the spirit and scope of the invention that is defined by the following claims.

What is claimed:

1. A rare earth element-doped, Bi₂O₃—Sb₂O₃—Al₂O₃—SiO₂ glass comprising about 1-50 mol % Bi₂O₃.

2. A glass according to claim 1, wherein the glass comprises about 0-4 mol % rare earth element oxide.

3. A glass according to claim 1, wherein the rare earth element in said rare earth element oxide is selected from the group consisting of Er, Tm, Yb, Nd, and Ce.

4. A glass according to claim 3, wherein the rare earth element is Er.

5. A glass according to claim 1, wherein the glass comprises:
about 1-60 mol % Sb₂O₃;
about 1-60 mol % Bi₂O₃;
about 0-20 mol % Al₂O₃;
about 20-90 mol % SiO₂; and
about 0-4 mol % Er₂O₃.

6. A glass according to claim 5, wherein the glass comprises about 21-60 mol % Sb₂O₃.

7. A glass according to claim 5, wherein the glass comprises about 10-60 mol % Bi₂O₃.

8. A glass according to claim 1, further comprising:
about 0-10 mol % B₂O₃ about 0-50 mol % GeO₂, about 0-15 mol % As₂O₃; or about 0-5 mol % of ZnO, TiO₂, Ga₂O₃, K₂O, or Na₂O.

9. An optical amplifier having an active region formed of a rare earth element-doped, Bi₂O₃—Sb₂O₃—Al₂O₃—SiO₂ glass comprising about 1-50 mol % Bi₂O₃.

10. An optical amplifier according to claim 9, wherein the glass comprises about 0-4 mol % rare earth element oxide.

11. An optical amplifier according to claim 10, wherein the rare earth element in said rare earth element oxide is selected from the group consisting of Er, Tm, Yb, Nd, and Ce.

12. An optical amplifier according to claim 11, wherein the rare earth element is Er.

13. An optical amplifier according to claim 9, wherein the glass comprises:
about 1-60 mol % Sb₂O₃;
about 1-60 mol % Bi₂O₃;
about 0-20 mol % Al₂O₃;
about 20-90 mol % SiO₂; and
about 0-4 mol % Er₂O₃.

14. An optical amplifier according to claim 13 wherein the glass comprises about 21-60 mol % Sb₂O₃.

15. An optical amplifier according to claim 13, wherein the glass comprises about 10-60 mol % Bi₂O₃.

16. An optical amplifier according to claim 9, wherein the optical amplifier is a fiber amplifier or a planar amplifier.
